(19) United States
(12) Patent Application Publication
(10) Pub. No.: US 2025/0269390 A1
(43) Pub. Date: Aug. 28, 2025

(54) APPARATUS AND METHODS FOR MAKING HONEYCOMB BODIES HAVING DEPOSITS OF INORGANIC PARTICLES

(71) Applicant: CORNING INCORPORATED, CORNING, NY (US)

(72) Inventors: Tiantong Li, Shanghai (CN); Guisong Lu, Shanghai (CN); He Wang, Shanghai (CN); Huiqing Wu, Shanghai (CN); Xinfeng Xing, Shanghai (CN); Jianqiang Zhu, Shanghai (CN)

(21) Appl. No.: 18/853,323

(22) PCT Filed: Apr. 28, 2022
(86) PCT No.: PCT/CN2022/089704

§ 371 Date: Oct. 1, 2024

(51) Int. Cl. B05B 7/14; B05B 12/10; B05B 12/12; B05D 1/12

(52) U.S. Cl. CPC B05B 7/1481; B05B 7/144; B05B 12/10; B05B 12/12; B05D 1/12; B05D 2203/30

(57) ABSTRACT

Apparatus and methods are provided for the manufacture of filtration articles. The apparatus and methods include a separate first chamber for dispersion of the inorganic particles and a larger second chamber for deposition of the inorganic particles on a single honeycomb body or multiple honeycomb bodies.

### BACKGROUND

### Field

The present specification relates to apparatus and methods of making porous bodies, such as porous ceramic honeycomb bodies, which comprise inorganic particle deposits.

### Technical Background

Wall-flow filters are employed to remove particulates from fluid exhaust streams, such as from combustion engine exhaust. Examples include diesel particulate filters used to remove particulates from diesel engine exhaust gases and gasoline particulate filters (GPF) used to remove particulates from gasoline engine exhaust gases. Exhaust gas to be filtered enters inlet cells and passes through the cell walls to exit the filter via outlet channels, with the particulates being trapped on or within the inlet cell walls as the gas traverses and then exits the filter.

A plugged honeycomb body (also referred to as a “filtration article”) provides a somewhat low initial filtration efficiency (FE) when it is in its “clean” (new or regenerated state). However, medium and higher efficiency filtration articles are required to provide high level of FE for air purification applications.

Air particulate filters can be used to filter particulates from the air in indoor and outdoor settings and wherever excessive particulate pollution can be present. In newly manufactured ceramic honeycomb filter bodies, filtration efficiency (measured as the percentage of particles in an airstream trapped by the filter) is low at first but increases as the filter begins to accumulate particles. There is a need for filter bodies having higher as-new (“clean”) filtration efficiency, so that a high filtration efficiency can be provided at the outset of use of a new or newly regenerated filter.

### SUMMARY

Aspects of the disclosure pertain to an apparatus configured to apply inorganic particles to porous bodies such as plugged honeycomb bodies and methods of applying inorganic particles to plugged honeycomb bodies.

In an aspect, an apparatus for making honeycomb bodies having inorganic particles filtration deposits is provided. In another aspect, a method for making honeycomb bodies having inorganic particles filtration deposits is provided.

Additional features and advantages will be set forth in the detailed description, which follows, and in part will be readily apparent to those skilled in the art from that description or recognized by practicing the embodiments described herein, comprising the detailed description, which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 schematically depicts a honeycomb body;

FIG. 2 schematically depicts a wall-flow particulate filter body according to embodiments disclosed and described herein;

FIG. 3 is a cross-sectional longitudinal view of a portion of the particulate filter body shown in FIG. 2;

FIG. 4 schematically depicts a portion of a wall of a honeycomb body of a particulate filter with particulate loading according to the present disclosure;

FIG. 5 schematically depicts an apparatus configured to generate an aerosol comprising inorganic particles which are deposited on a plugged honeycomb body in a deposition section according to an embodiment of the present disclosure;

FIG. 6 schematically depicts an aerosol generator according to an embodiment of the present disclosure;

FIG. 7 schematically depicts a Venturi tube used in an aerosol generator shown in FIG. 6 according to an embodiment of the present disclosure;

FIG. 8 is an isometric view of a portion of the aerosol generator shown in FIG. 6;

FIG. 9 is a flowchart of an exemplary embodiment of a method of generating an aerosol according to an embodiment of the present disclosure;

FIG. 10 schematically depicts an apparatus including a dispersion section and a deposition section according to an embodiment of the present disclosure;

FIG. 11 depicts a carrier for holding a plurality of plugged honeycomb bodies according to an embodiment of the present disclosure;

FIG. 12 depicts a method according to an embodiment of the present disclosure; and

FIGS. 13A and 13B are graphs showing filtration efficiency vs. loading.

### DETAILED DESCRIPTION

Reference will now be made in detail to embodiments of methods for forming honeycomb bodies comprising a porous honeycomb body comprising inorganic particle deposits (or “filtration deposits”) on, or in, or both on and in, the porous ceramic walls of the honeycomb body matrix, embodiments of which are illustrated in the accompanying drawings. Filtration deposits comprise material that was deposited into the honeycomb body, as well as compounds that may be formed, for example, by heating, from one or materials that were originally deposited. For example, a surfactants may be transformed by heating into an organic component which is eventually burned off or volatilized, while an inorganic component remains contained within the honeycomb filter body. Whenever possible, the same reference numerals will be used throughout the drawings to refer to the same or like parts.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise. As used herein, “have”, “having”, “include”, “including”, “comprise”, “comprising” or the like are used in their open ended sense, and generally mean “including, but not limited to”.

A “honeycomb body,” as referred to herein, comprises a ceramic honeycomb structure of a matrix of intersecting walls that form cells which define channels. The ceramic honeycomb structure can be formed, extruded, or molded from a plasticized ceramic or ceramic-forming batch mixture or paste. A honeycomb body may comprise an outer peripheral wall, or skin, which was either extruded along with the matrix of walls or applied after the extrusion of the matrix. For example, a honeycomb body can be a plugged ceramic honeycomb structure which forms a filter body comprised of cordierite or other suitable ceramic material. A plugged honeycomb body has one or more channels plugged at one, or both ends of the body.

“Air particulate filters” refers to filters that can be used to filter particulates from the air in indoor and outdoor settings and wherever excessive particulate pollution can be present. In one or more embodiments, air particulate filters employ filter bodies formed of porous-walled ceramic honeycombs which can trap particulates, filtering them from the air passing through the bodies.

A honeycomb body disclosed herein comprises a ceramic honeycomb structure comprising at least one wall carrying one or more filtration material deposits which is configured to filter particulate matter from a gas stream. The filtration material deposits can be in discrete regions or in some portions or some embodiments can make one or more layers of filtration material at a given location on the wall of the honeycomb body. The filtration material deposits preferably comprise inorganic particles, which in some embodiments, are mixed with up to 50 wt. % organic material such as a surfactant. For example, a honeycomb body may, in one or more embodiments, be formed from cordierite or other porous ceramic material and further comprise inorganic particles deposits disposed on or below wall surfaces of the cordierite honeycomb structure.

In some embodiments, the filtration material comprises one or more inorganic particles. As used herein, “green” or “green ceramic” are used interchangeably and refer to an unsintered or unfired material, unless otherwise specified.

### General Overview of Plugged Honeycomb Bodies

The ceramic articles herein comprise honeycomb bodies comprised of a porous ceramic honeycomb structure of porous walls having wall surfaces defining a plurality of inner channels.

In some embodiments, the porous ceramic walls comprise a material such as a filtration material which may comprise in some portions or some embodiments a porous inorganic particles layer disposed on one or more surfaces of the walls. In some embodiments, the filtration material comprises one or more inorganic particles. In some embodiments, the filtration material is disposed on the walls to provide enhanced filtration efficiency, both locally through and at the wall and globally through the honeycomb body, at least in the initial use of the honeycomb body as a filter following a clean state, or regenerated state, of the honeycomb body, for example such as before a substantial accumulation of ash and/or soot occurs inside the honeycomb body after extended use of the honeycomb body as a filter.

In one aspect, the filtration material is present in some portions or some embodiments as a layer disposed on the surface of one or more of the walls of the honeycomb structure. The layer in some embodiments is porous to allow the gas flow through the wall. In some embodiments, the layer is present as a continuous coating over at least part of the, or over the entire, surface of the one or more walls.

In another aspect, the filtration material is present as a plurality of discrete regions of filtration material disposed on the surface of one or more of the walls of the honeycomb structure. The filtration material may partially block a portion of some of the pores of the porous walls, while still allowing gas flow through the wall. In some embodiments of this aspect, the filtration material is aerosol-deposited filtration material. In some preferred embodiments, the filtration material comprises a plurality of inorganic particle agglomerates, wherein the agglomerates are comprised of inorganic particles, for example, particles of alumina, calcium carbonate, kaolin, Portland cement, glass, CuO₂, wollastonite, talcum powder, mica powder, silica powder, brucite powder, pyrophyllite, coal ash, dolomite, sepiolite, or combinations thereof. In some embodiments, the agglomerates are porous, thereby allowing gas to flow through the agglomerates. In specific embodiments, the “inorganic particles” of the honeycomb filter body are non-engine generated inorganic particles. That is, the inorganic particles of the honeycomb filter body are not soot or metals or the like coming from the engine exhaust itself. Rather, the inorganic particles of the honeycomb filter body are present from manufacture of the article itself. In one or more embodiments, the inorganic particles of the honeycomb body are ceramic particles or particles of refractory material, or refractory particles. In one or more embodiments, the inorganic particles of the honeycomb body are free from rare earth oxides such as ceria, lanthana, and yttria. In one or more embodiments, the inorganic particles are free from catalyst, for example, an oxidation catalyst such as a platinum group metal (e.g., platinum, palladium and rhodium) or a selective catalytic reduction catalyst such as a copper, a nickel or an iron promoted molecular sieve (e.g., a zeolite).

In some embodiments, a honeycomb body comprises a porous ceramic honeycomb body comprising a first end, a second end, and a plurality of walls having wall surfaces defining a plurality of inner channels. A deposited material such as a filtration material, which may be in some portions or some embodiments a porous inorganic particles layer, is disposed on one or more of the wall surfaces of the honeycomb body. The deposited material such as a filtration material, which may be a porous inorganic particles layer has a porosity as measured by mercury intrusion porosimetry, SEM, or X-ray tomography in a range of from about 20% to about 95%, or from about 25% to about 95%, or from about 30% to about 95%, or from about 40% to about 95%, or from about 45% to about 95%, or from about 50% to about 95%, or from about 55% to about 95%, or from about 60% to about 95%, or from about 65% to about 95%, or from about 70% to about 95%, or from about 75% to about 95%, or from about 80% to about 95%, or from about 85% to about 95%, or from about 20% to about 90%, or from about 25% to about 90%, or from about 30% to about 90%, or from about 40% to about 90%, or from about 45% to about 90%, or from about 50% to about 90%, or from about 55% to about 90%, or from about 60% to about 90%, or from about 65% to about 90%, or from about 70% to about 90%, or from about 75% to about 90%, or from about 80% to about 90%, or from about 85% to about 90%, or from about 20% to about 85%, or from about 25% to about 85%, or from about 30% to about 85%, or from about 40% to about 85%, or from about 45% to about 85%, or from about 50% to about 85%, or from about 55% to about 85%, or from about 60% to about 85%, or from about 65% to about 85%, or from about 70% to about 85%, or from about 75% to about 85%, or from about 80% to about 85%, or from about 20% to about 80%, or from about 25% to about 80%, or from about 30% to about 80%, or from about 40% to about 80%, or from about 45% to about 80%, or from about 50% to about 80%, or from about 55% to about 80%, or from about 60% to about 80%, or from about 65% to about 80%, or from about 70% to about 80%, or from about 75% to about 80%, and the deposited material such as a filtration material, which may be a porous inorganic particles layer that has an average thickness from greater than or equal to 25 μm to less than or equal to 250 μm, such as from greater than or equal to 45 μm to less than or equal to 230 μm, greater than or equal to 65 μm to less than or equal to 210 μm, greater than or equal to 65 μm to less than or equal to 190 μm, or greater than or equal to 85 μm to less than or equal to 170 μm. Various embodiments of plugged honeycomb bodies and methods for forming such honeycomb bodies will be described herein with specific reference to the appended drawings.

The material in some embodiments comprises a filtration material, and in some embodiments comprises an inorganic particles filtration material. According to one or more embodiments, the inorganic particles filtration material provided herein comprises discrete regions and/or a discontinuous layer formed from the inlet end to the outlet end comprising discrete and disconnected patches of material or filtration material and binder comprised of primary particles in secondary particles or agglomerates that are substantially spherical. In one or more embodiments, the primary particles are non-spherical. In one or more embodiments, “substantially spherical” refers to agglomerate having circularity in cross section in a range of from about 0.8 to about 1 or from about 0.9 to about 1, with 1 representing a perfect circle. In one or more embodiments, 75% of the primary particles deposited on the honeycomb body have a circularity of less than 0.8.

Circularity can be measured using a scanning electron microscope (SEM). The term “circularity of the cross-section (or simply circularity)” is a value expressed using the equation shown below. A circle having a circularity of 1 is a perfect circle.

Circularity=(4π×cross-sectional area)/(length of circumference of the cross-section)².

A honeycomb body of one or more embodiments may comprise a honeycomb structure and deposited material such as a filtration material disposed on one or more walls of the honeycomb structure. In some embodiments, the deposited material such as a filtration material is applied to surfaces of walls present within honeycomb structure, where the walls have surfaces that define a plurality of inner channels.

The inner channels, when present, may have various cross-sectional shapes, such as circles, ovals, triangles, squares, pentagons, hexagons, or tessellated combinations or any of these, for example, and may be arranged in any suitable geometric configuration. The inner channels, when present, may be discrete or intersecting and may extend through the honeycomb body from a first end thereof to a second end thereof, which is opposite the first end.

Before describing several exemplary embodiments of the disclosure, it is to be understood that the disclosure is not limited to the details of construction or process steps set forth in the following description. The disclosure is capable of other embodiments and of being practiced or being carried out in various ways.

Aspect and methods of the present disclosure relate to application of inorganic particles to a plugged honeycomb body comprising porous walls. In one or more embodiments, two chambers, a dispersion section and a deposition section, are utilized in apparatus and methods described herein to simultaneously apply inorganic particles to a plurality of plugged honeycomb bodies. In one or more embodiments, the inorganic particles comprise particles of alumina, calcium carbonate, kaolin, Portland cement, glass, CuO₂, wollastonite, talcum powder, mica powder, silica powder, brucite powder, pyrophyllite, coal ash, dolomite, sepiolite, or combinations thereof.

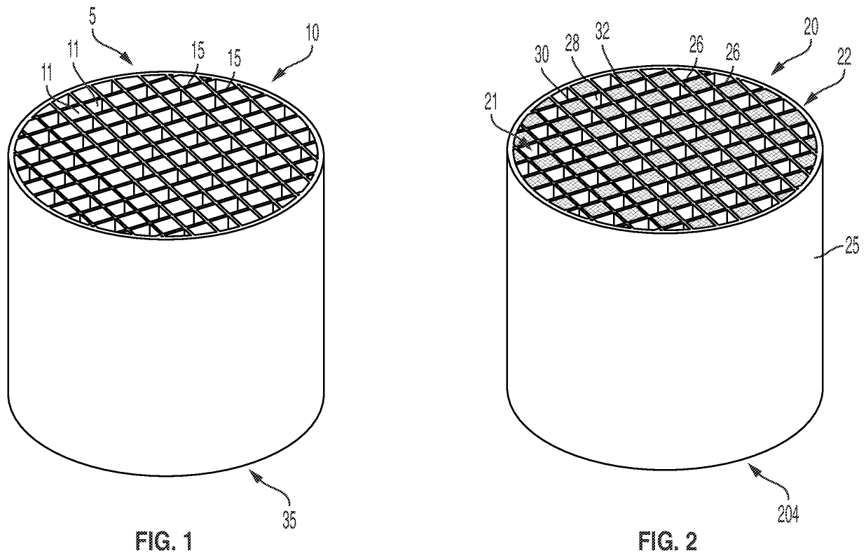

With reference now to FIG. 1, a honeycomb body 10 according to one or more embodiments shown and described herein is depicted. The honeycomb body 10 may, in embodiments, comprise a plurality of walls 15 defining a plurality of inner channels 11. The plurality of inner channels 11 and intersecting channel walls 15 extend between first end 5, which may be an inlet end, and second end 35, which may be an outlet end, of the honeycomb body 10. The honeycomb body may have one or more of the channels plugged on one, or both of the first end 5 and the second end 35, as further described below in reference to FIG. 2. The pattern of plugged channels of the honeycomb body is not limited. In some embodiments, a pattern of plugged and unplugged channels at one end of the plugged honeycomb body may be, for example, a checkerboard pattern where alternating channels of one end of the plugged honeycomb body are plugged. In some embodiments, plugged channels at one end of the plugged honeycomb body have corresponding unplugged channels at the other end, and unplugged channels at one end of the plugged honeycomb body have corresponding plugged channels at the other end.

In one or more embodiments, the plugged honeycomb body may be formed from cordierite, aluminum titanate, enstatite, mullite, forsterite, corundum (SiC), spinel, sapphirine, and periclase, and combinations thereof. In general, cordierite has a composition according to the formula Mg₂A₁₄Si₅O₁₈. In some embodiments, the pore size of the ceramic material, the porosity of the ceramic material, and the pore size distribution of the ceramic material are controlled, for example by varying the particle sizes of the ceramic raw materials. In addition, pore formers can be included in ceramic batches used to form the honeycomb body with certain porosity.

In some embodiments, walls of the plugged honeycomb body may have an average thickness from greater than or equal to 25 μm to less than or equal to 250 μm, such as from greater than or equal to 45 μm to less than or equal to 230 μm, greater than or equal to 65 μm to less than or equal to 210 μm, greater than or equal to 65 μm to less than or equal to 190 μm, or greater than or equal to 85 μm to less than or equal to 170 μm.

In one or more embodiments, the bulk of the plugged honeycomb body (prior to applying any filtration material) has a median pore size from greater than or equal to 7 μm to less than or equal to 25 μm, such as from greater than or equal to 10 μm to less than or equal to 22 μm, or from greater than or equal to 10 μm to less than or equal to 18 μm. For example, in some embodiments, the bulk of the plugged honeycomb body may have bulk median pore sizes of about 10 μm, about 11 μm, about 12 μm, about 13 μm, about 14 μm, about 15 μm, about 16 μm, about 17 μm, about 18 μm, about 19 μm, or about 20 μm. The term “median pore size” or “d50” (prior to applying any filtration material) refers to a diametrical length measurement, above which the pore sizes of 50% of the pores lie and below which the pore sizes of the remaining 50% of the pores lie, based on the statistical distribution of all the pores.

In specific embodiments, the median pore size (d50) of the bulk of the plugged honeycomb body (prior to applying any filtration material) is in a range of from 10 μm to about 16 μm, for example 13-14 μm, and the d10 refers to a length measurement, above which the pore sizes of 90% of the pores lie and below which the pore sizes of the remaining 10% of the pores lie, based on the statistical distribution of all the pores is about 7 μm. In specific embodiments, the d90 refers to a length measurement, above which the pore sizes of 10% of the pores of the bulk of the plugged honeycomb body (prior to applying any filtration material) lie and below which the pore sizes of the remaining 90% of the pores lie, based on the statistical distribution of all the pores is about 30 μm.

In some embodiments, the bulk of the plugged honeycomb body may have bulk porosities, not counting a coating, of from greater than or equal to 50% to less than or equal to 75% as measured by mercury intrusion porosimetry. Other methods for measuring porosity include scanning electron microscopy (SEM) and X-ray tomography; these two methods in particular are valuable for measuring surface porosity and bulk porosity independent from one another. In one or more embodiments, the bulk porosity of the plugged honeycomb body may be in a range of from about 50% to about 75%, in a range of from about 50% to about 70%, in a range of from about 50% to about 65%, in a range of from about 50% to about 60%, in a range of from about 50% to about 58%, in a range of from about 50% to about 56%, or in a range of from about 50% to about 54%, for example.

In some embodiments, the surface of the plugged honeycomb body may have surface porosities, prior to application of a filtration material deposit, of from greater than or equal to 35% to less than or equal to 75% as measured by SEM or X-ray tomography. In one or more embodiments, the surface porosity of the plugged honeycomb body may be less than 65%, such as less than 60%, less than 55%, less than 50%, less than 48%, less than 46%, less than 44%, less than 42%, less than 40%, less than 48%, or less than 36% for example.

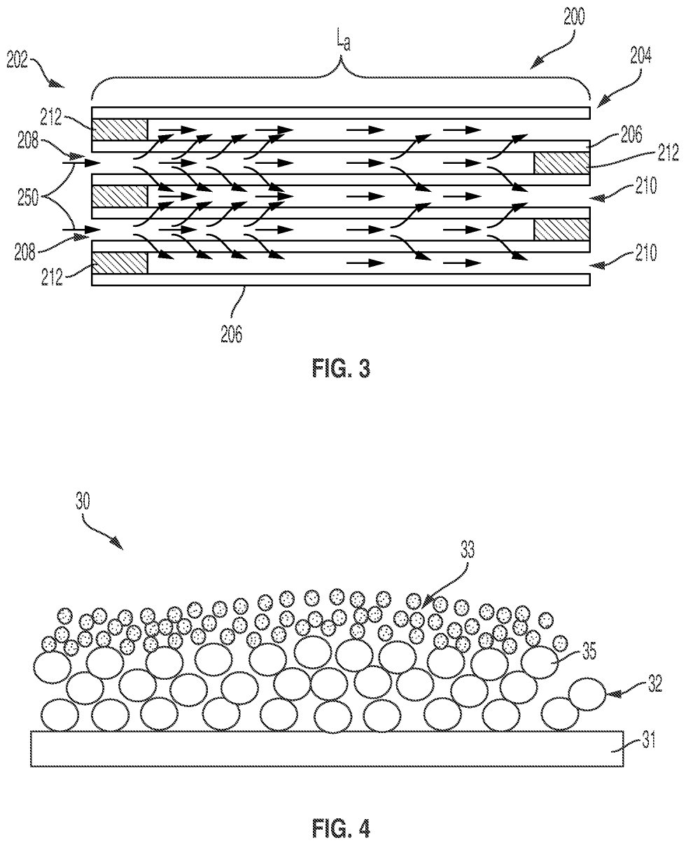

Referring now to FIGS. 2 and 3, a plugged honeycomb body, or plugged honeycomb particulate filter body 20 is schematically depicted. The particulate filter body 20 may be used as a wall-flow filter to filter particulate matter from an exhaust gas stream 25, such as an exhaust gas stream emitted from a gasoline engine, in which case the particulate filter body 20 is in the form of an air particulate filter. The particulate filter body 20 generally comprises a honeycomb body having a plurality of channels 21 or cells which extend between an inlet end 22 and an outlet end 24, defining an overall length La (shown in FIG. 3). The channels 21 of the particulate filter body 20 are formed by, and at least partially defined by a plurality of intersecting channel walls 26 that extend from the inlet end 22 to the outlet end 24. The particulate filter body 20 may also include a skin layer 25 surrounding the plurality of channels 21. This skin layer 25 may be extruded during the formation of the channel walls 26 or formed in later processing as an after-applied skin layer, such as by applying a skinning cement to the outer peripheral portion of the channels.

An axial cross section of the particulate filter body 20 of FIG. 2 is shown in FIG. 3. In some embodiments, certain channels are designated as inlet channels 28 and certain other channels are designated as outlet channels 30. In some embodiments of the particulate filter body 20, at least a first set of channels is plugged with plugs 32. Generally, the plugs 32 are disposed proximate the ends (i.e., the inlet end and/or the outlet end) of the channels 21. The plugs are arranged in a pre-defined pattern, such as in the checkerboard pattern shown in FIG. 2 with every other channel being plugged at an end. The inlet channels 28 may be plugged at or near the outlet end 24, and the outlet channels 21 may be plugged at or near the inlet end 22 on channels not corresponding to the inlet channels, as depicted in FIG. 3. Accordingly, each cell may be plugged at or near one end of the particulate filter only.

While FIG. 2 generally depicts a checkerboard plugging pattern, it should be understood that alternative plugging patterns may be used in the porous ceramic honeycomb article. In the embodiments described herein, the particulate filter body 20 may be formed with a channel density of up to about 600 channels per square inch (cpsi). For example, in some embodiments, the particulate filter body 200 may have a channel density in a range from about 100 cpsi to about 600 cpsi. In some other embodiments, the particulate filter body 20 may have a channel density in a range from about 100 cpsi to about 400 cpsi or even from about 100 cpsi to about 300 cpsi, for example, 100 cpsi to about 200 cpsi.

In the embodiments described herein, the channel walls 26 of the particulate filter body 20 may have a thickness of greater than about 4 mils (101.6 micrometers). For example, in some embodiments, the thickness of the channel walls 26 may be in a range from about 4 mils up to about 30 mils (762 micrometers). In some other embodiments, the thickness of the channel walls 26 may be in a range from about 7 mils (177.8 micrometers) to about 20 mils (508 micrometers).

In some embodiments of the particulate filter body 20 described herein the channel walls 26 of the particulate filter body 20 may have a bare open porosity (i.e., the porosity before any coating is applied to the plugged honeycomb body) % P=35% prior to the application of any coating to the particulate filter body 200. In some embodiments the bare open porosity of the channel walls 206 may be such that 40%≤% P≤75%. In other embodiments, the bare open porosity of the channel walls 206 may be such that 45%≤% P≤75%, 50%≤% P≤75%, 55%≤% P≤75%, 60%≤% P≤75%, 45%≤% P≤70%, 50%≤% P≤70%, 55%≤% P≤70%, or 60%≤% P≤70%.

Further, in some embodiments, the channel walls 26 of the particulate filter body 20 are formed such that the pore distribution in the channel walls 26 has a median pore size of ≤30 micrometers prior to the application of any coatings (i.e., bare). For example, in some embodiments, the median pore size may be ≥8 micrometers and less than or ≤30 micrometers. In other embodiments, the median pore size may be ≥10 micrometers and less than or ≤30 micrometers. In other embodiments, the median pore size may be ≥10 micrometers and less than or ≤25 micrometers. In some embodiments, particulate filters produced with a median pore size greater than about 30 micrometers have reduced filtration efficiency while with particulate filters produced with a median pore size less than about 8 micrometers may be difficult to infiltrate the pores with a washcoat containing a catalyst. Accordingly, in some embodiments, it is desirable to maintain the median pore size of the channel wall in a range of from about 8 micrometers to about 30 micrometers, for example, in a range of rom 10 micrometers to about 20 micrometers.

In one or more embodiments described herein, the plugged honeycomb body of the particulate filter body 20 is formed from a metal or ceramic porous material such as, for example, cordierite, silicon carbide, aluminum oxide, aluminum titanate or any other ceramic material suitable for use in elevated temperature particulate filtration applications. For example, the particulate filter body 20 may be formed from cordierite by mixing a batch of ceramic precursor materials which comprise constituent materials suitable for producing a ceramic article which when fired predominately comprises a cordierite crystalline phase. Constituent materials suitable for cordierite formation include a combination of inorganic components including talc, a silica-forming source, and an alumina-forming source. The batch mixture may additionally comprise clay, such as, for example, kaolin clay. The cordierite precursor batch composition may also contain organic components, such as organic pore formers, which are added to the batch mixture to achieve the desired pore size distribution upon firing. For example, the batch composition may comprise a starch which is suitable for use as a pore former and/or other processing aids. Alternatively, the constituent materials may comprise one or more cordierite powders suitable for forming a sintered cordierite honeycomb structure upon firing as well as an organic pore former material.

The batch composition may additionally comprise one or more processing aids such as, for example, a surfactant and a liquid vehicle, such as water or a suitable solvent. The processing aids are added to the batch mixture to plasticize the batch mixture and to generally improve processing, reduce the drying time, reduce cracking upon firing, and/or aid in producing the desired properties in the plugged honeycomb body. For example, the surfactant can include an organic surfactant. Suitable organic surfactants include water soluble cellulose ether surfactants such as methylcellulose, hydroxypropyl methylcellulose, methylcellulose derivatives, hydroxyethyl acrylate, polyvinyl alcohol, and/or any combinations thereof. Incorporation of the organic surfactant into the plasticized batch composition allows the plasticized batch composition to be readily extruded. In some embodiments, the batch composition may include one or more optional forming or processing aids such as, for example, a lubricant which assists in the extrusion of the plasticized batch mixture.

After the batch of ceramic precursor materials is mixed with the appropriate processing aids, the batch of ceramic precursor materials is extruded and cut and dried to form a green honeycomb body comprising an inlet end and an outlet end with a plurality of channel walls extending between the inlet end and the outlet end. Thereafter, the green honeycomb body is fired according to a firing schedule suitable for producing a fired ceramic honeycomb body. At least a first set of the channels of the fired ceramic honeycomb body are then plugged in a predefined plugging pattern with a ceramic plugging composition. The plugs of the honeycomb body can then dried or cured, or the fired honeycomb body can be fired again to ceram the plugs, in order to secure the plugs and seal the respective channels.

According to the present disclosure, the plugged honeycomb body constitutes or forms an air particulate filter body. Thus the median pore size, porosity, geometry and other design aspects of both the bulk and the surface pores of the plugged honeycomb body are selected and/or provided taking into account the desired filtration performance of the air particulate filter body. As shown in the embodiment of FIG. 4, walls 31 of the plugged honeycomb body 30, which represents a portion of the structure as shown in FIGS. 2 and 3, also have deposits 30 of inorganic particles 35 disposed thereon. The deposits 30 comprise inorganic particles 35 that are deposited on the wall 31 of the plugged honeycomb body 30 and help prevent particles of pollutant, such as, for example, soot and/or ash, from exiting the plugged honeycomb body along with a gas stream, and to help prevent the pollutant from clogging the walls 31 of the plugged honeycomb body 30. In this way, and according to embodiments herein, the deposits 30 of inorganic particle 35 can serve as a filtration component while the walls 310 of the plugged honeycomb body also filter, and can be also configured to minimize pressure drop relative to filtration performance. The deposits 30 of inorganic particles 35 can be delivered by the apparatus and deposition methods described herein.

The filtration material deposits are delivered by the apparatus and deposition methods disclosed herein.

The filtration or deposited material, which in some portions or some embodiments may be inorganic particle deposits or an inorganic particles layer or membrane or islands disposed in and/or on walls of the plugged honeycomb body can be very thin compared to thickness of the base portion of the walls of the plugged honeycomb body. In some embodiments, in or on one or more portions of the walls of the honeycomb body, the average thickness of the material, which may be deposit regions or an inorganic particles layer or membrane, on the base portion of the walls of the plugged honeycomb body is greater than or equal to 0.5 μm and less than or equal to 50 μm, or greater than or equal to 0.5 μm and less than or equal to 45 μm, greater than or equal to 0.5 μm and less than or equal to 40 μm, or greater than or equal to 0.5 μm and less than or equal to 35 μm, or greater than or equal to 0.5 μm and less than or equal to 30 μm, greater than or equal to 0.5 μm and less than or equal to 25 μm, or greater than or equal to 0.5 μm and less than or equal to 20 μm, or greater than or equal to 0.5 μm and less than or equal to 15 μm, greater than or equal to 0.5 μm and less than or equal to 10 μm. In one or more embodiments, the inorganic particles comprise particles of alumina, calcium carbonate, kaolin, Portland cement, glass, CuO₂, wollastonite, talcum powder, mica powder, silica powder, brucite powder, pyrophyllite, coal ash, dolomite, sepiolite, or combinations thereof. In one or more embodiments, the inorganic particle deposits have a porosity as measured by mercury intrusion porosimetry, SEM, or X-ray tomography in a range 30% to 95% and all values and subranges therebetween. In one or more embodiments, the inorganic particle deposits disposed within the honeycomb filter body are at a loading of less than or equal to 20 grams of the inorganic particle deposits per liter of the honeycomb filter body, or of less than or equal to 15 grams of the inorganic particle deposits per liter of the honeycomb filter body, or less than or equal to 10 grams of the inorganic particle deposits per liter of the honeycomb filter body, less than or equal to 7 grams of the inorganic particle deposits per liter of the honeycomb filter body, or less than or equal to 5 grams of the inorganic particle deposits per liter of the honeycomb filter body. In some embodiments, an increase in pressure drop across the honeycomb due to the application of the inorganic particle deposits is less than 100% of the pressure drop of the uncoated honeycomb. In other embodiments that increase can be less than or equal to 50%, or less than or equal to 30%. In other embodiments, the pressure drop increase across the honeycomb body is less than or equal to 7%, such as less than or equal to 6%. In still other embodiments, the pressure drop increase across the honeycomb body is less than or equal to 5%, such as less than or equal to 4%, or less than or equal to 3%.

In one or more embodiments, the inorganic particles, or at least some of the inorganic particles, are coated with a surfactant. In one or more embodiments, the surfactant is one of a fatty acid including a stearate, a phosphate, or a sulfonate fatty acid; a polymer including polymethyl methacrylate, polyethylene glycol, a polyvinyl alcohol, a polymeric acid, a polyacrylic acid, polypropylene, or polyethylene; or mixtures thereof. In one or more embodiments, the surfactant comprises stearic acid. The surfactant can assist in imparting humidity resistance to inorganic particles that are hydrophilic. The surfactant can also assist in preventing excessive agglomeration of the inorganic particles.

In one or more embodiments, the deposits have a porosity as measured by mercury intrusion porosimetry in a range of from greater than 95% to less than or equal to 99.9%, or from greater than or equal 95.5% to less than or equal 99.85%, or from greater than or equal 96% to less than or equal 99.8%, or from greater than or equal 96.5% to less than or equal 99.75%, or from greater than or equal 97% to less than or equal 99.7%, or from greater than or equal 97.5% to less than or equal 99.65%, or from greater than or equal 98% to less than or equal 99.6%, or from greater than or equal 98.5% to less than or equal 99.55%, or from greater than or equal 99% to less than or equal 99.5%, and all values and subranges therebetween. In one or more embodiments, the deposits disposed within the honeycomb filter body are at a loading of less than or equal to 20 grams of the deposits per liter of the honeycomb filter body, or of less than or equal to 15 grams of the deposits per liter of the honeycomb filter body, or less than or equal to 10 grams of the deposits per liter of the honeycomb filter body, less than or equal to 7 grams of the deposits per liter of the honeycomb filter body, or less than or equal to 5 grams of the deposits per liter of the honeycomb filter body.

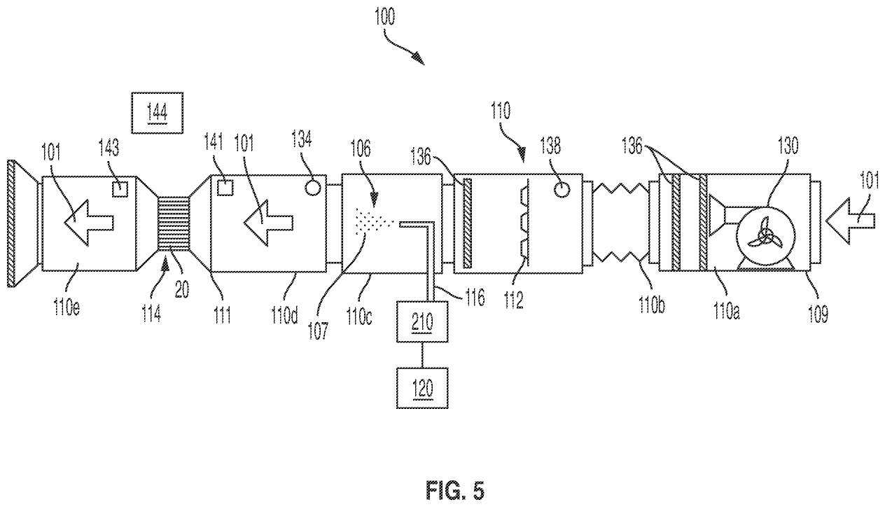

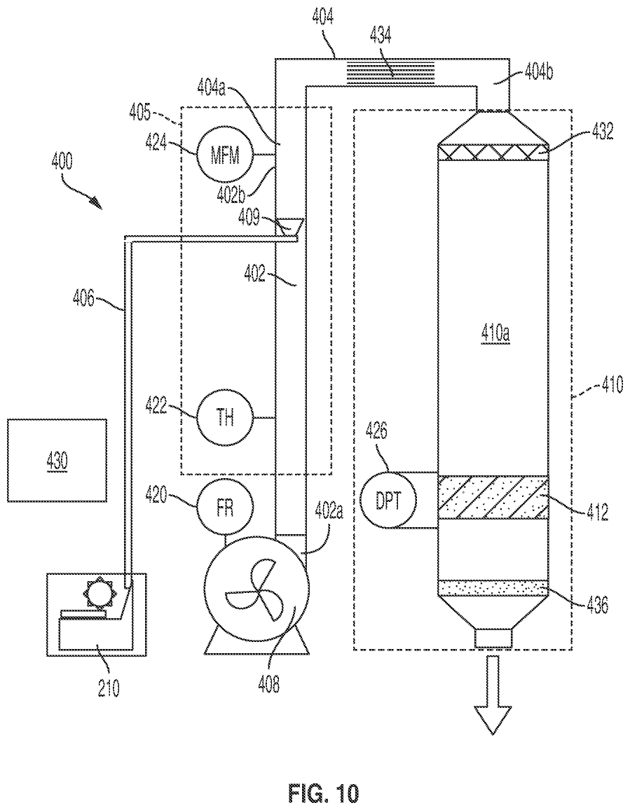

Referring now to FIG. 5, an embodiment of an aerosol generator apparatus 103 configured to generate an aerosol comprising inorganic particles 107 to a plurality of plugged honeycomb bodies in a downstream deposition section (shown in FIG. 10) is shown. In one or more embodiments, each of the plurality of plugged honeycomb bodies is the type shown in FIGS. 2 and 3, and the plugged honeycomb body 20 comprises porous walls, an inlet end and an outlet end. The aerosol generator apparatus 100 shown in FIG. 5 comprises a duct 110 spanning from a first end to a second end 111. The duct 110 can comprise a single unitary section of duct, or a plurality of duct sections 110a, 110b, 110c, and 110d as shown in FIG. 5. The plurality of duct sections 110a, 110b, 110c, and 110d can be joined together by collars or other suitable joining. One or more of the duct sections 110a, 110b, 110c, and 110d can comprise rigid duct material or flexible duct material.

An inlet conduit 116 is in fluid communication with the duct 110. In FIG. 5, the arrows 101 depict a direction of gas (e.g., air) flow through the aerosol generator apparatus, in particular through the duct 110. The term “upstream” refers to a position or location in the apparatus that encounters flow before another position or location in the apparatus. Likewise, “downstream” refers to a position or location in the apparatus that encounters flow after another position or location in the apparatus. Thus, the first end 109 of the duct 110 encounters flow through the apparatus prior to the second end 111 of the duct 110, and the second end 111 of the duct 110 encounters flow through the apparatus prior to the separate deposition section such as section 114.

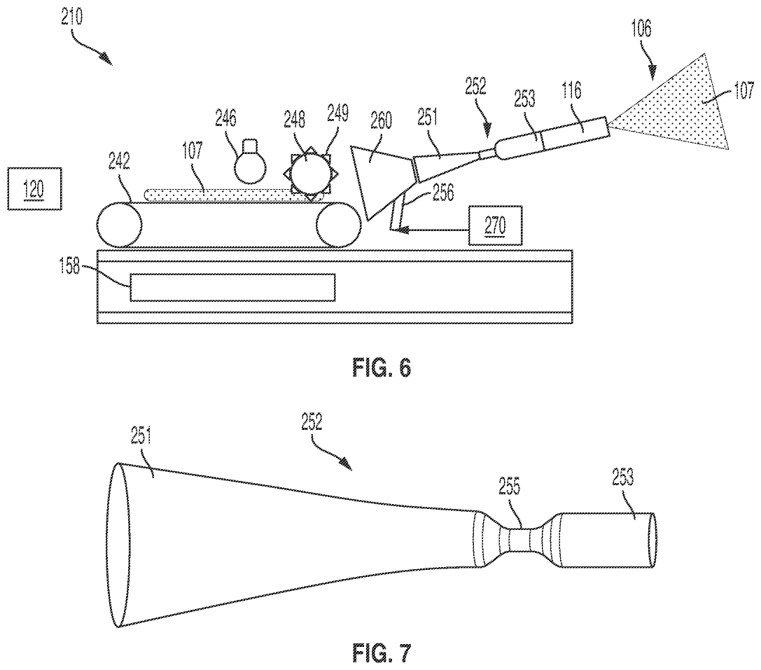

In the embodiment shown in FIG. 5, an inorganic particle source 120 is in fluid communication with the inlet conduit 116 and configured to supply inorganic particles 107 to the inlet conduit 116 and into the duct 110. An aerosol generator 210 comprising a Venturi tube 252 such as shown in FIG. 6 comprising a first end 251 and a second end 253 is in fluid communication with the inlet conduit 116. The aerosol generator 210 is configured to deliver an aerosol stream 106 comprising the inorganic particles 107 and gas (e.g., air) to a deposition section 114.

Continuing with the embodiment shown in FIG. 5, a flow generator 130 is in fluid communication with the duct 110 and the deposition section 114, the flow generator 130 being configured to establish a flow of a gas (e.g., air) and the inorganic particles 107 introduced into the duct 110 by the aerosol generator 210. Non-limiting examples of a flow generator 130 include a fan, a blower and/or a vacuum pump, which establishes a fluid flow, such as a gas flow (e.g., an air flow, nitrogen flow, or inert gas flow) in the direction of arrows 101.

In one or more embodiments, the aerosol generator 210 is configured to deliver a dry aerosol to the deposition section 410. According to one or more embodiments, “dry aerosol” refers to an aerosol comprising a gas, such as air, and inorganic particles. In some embodiments, a dry aerosol consists essentially of inorganic particles and a gas, such as air, and no surfactant or added liquid is contained in the aerosol. In some embodiments, the dry aerosol may comprise a small amount of liquid or moisture, such as from ambient conditions, for example from 0.0001% to 5% by weight of the inorganic particle weight, from 0.0001% to 4% by weight, from 0.0001% to 3% by weight, from 0.0001% to 2% by weight, from 0.0001% to 1% by weight, from 0.0001% to 0.5% by weight, from 0.0001% to 0.4% by weight, from 0.0001% to 0.3% by weight, from 0.0001% to 0.2% by weight, from 0.0001% to 0.1% by weight, from 0.0001% to 0.01% by weight, or 0% liquid or moisture.

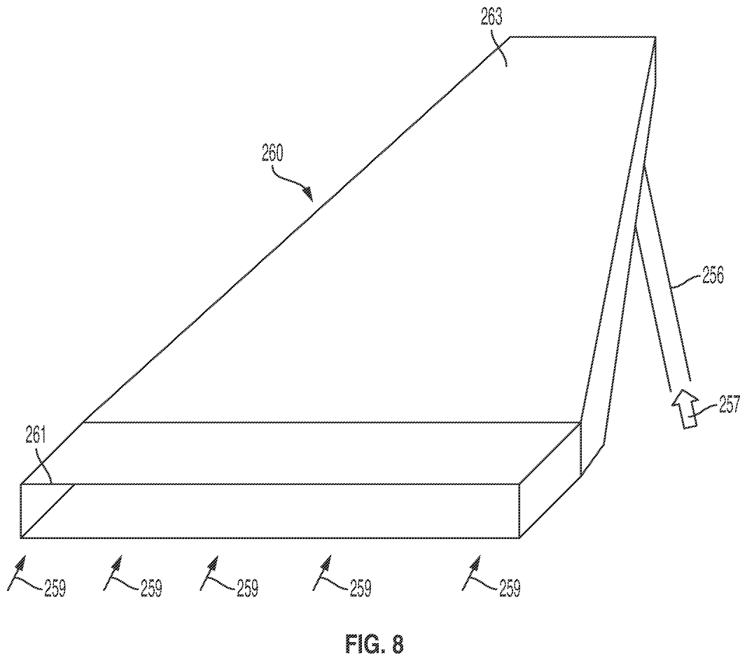

As shown in FIG. 6 and FIG. 8, the aerosol generator 210 further preferably comprises a delivery conduit 260 having a flared first end 261 configured to receive the inorganic particles 107 from the inorganic particle source 120. The delivery conduit 260 further comprises a second end 263 connected to the first end 251 of the Venturi tube 252, and a second end 253 of the Venturi tube 252 is connected to the inlet conduit 116. In the embodiment shown, the aerosol generator apparatus further comprises pressurized gas source 270 in communication with the delivery conduit 260. In the embodiment shown, the pressurized gas source 270 may comprise a tank or cylinder of gas, such as air or nitrogen. The tank or cylinder can include a pressure regulator to regulate the flow of pressurized gas into a gas conduit 256. In some embodiments, the pressurized gas source 270 comprises an air compressor.

Referring now to FIG. 7, the Venturi tube 252 includes a reduced cross-sectional area portion 255 between the first end 251 and the second end of the Venturi tube. In a Venturi tube, when a fluid such as a gas and/or liquid or an aerosol comprised of a fluid such as a gas and/or liquid flows through the Venturi tube, a “Venturi effect” can be generated. The Venturi effect is the reduction in fluid pressure that results when a fluid or aerosol flows through a constricted section (or choke) of a pipe.

Referring back to FIG. 6, the aerosol generator 210 of the aerosol generator apparatus further comprises an inorganic particle feed system 242 configured to deliver the inorganic particles 107 from the inorganic particle source 120 to the inlet conduit 116. The inorganic particles 107 from the inorganic particle source 120 in some embodiments are introduced to the delivery conduit by the inorganic particle feed system 242, which in the embodiment shown is a conveyor. The inorganic particle feed system 242 according to one or more embodiments comprises a gravity feed system, a screw auger, a belt conveyor, a chain conveyor, or other suitable device to introduce the inorganic particles 107 to the delivery conduit 260.

FIG. 8 shows an isometric view of the delivery conduit 260 according to one or more embodiments. The high pressure flow of gas indicated by arrow 257 through the gas conduit 256 causes gas to flow through the flared end 261 of delivery conduit 260 as shown by arrows 259 adjacent the flared end 261. This flow of gas indicated by arrows 259 entrains, draws up or sucks up particles 107 from inorganic particle feed system 242 into the flared end 261 of the delivery conduit 260 and out the second end 263 of the delivery conduit 260. The inorganic particles 107 then enter the Venturi tube 252 wherein the particles are mixed with gas and form an aerosol 106 comprised of the inorganic particles 107 and the gas, and the aerosol 106 is delivered into the duct 110 at duct section 110c through the inlet conduit 116. The flow of gas (e.g., air) in the duct 110 indicated by arrows 101 causes the aerosol 106 comprising the inorganic particles 107 in the duct 110 to be transported to the plugged honeycomb body 108 located in the deposition section. Gas flows through the plugged honeycomb body.

In the embodiment shown in FIG. 5 and FIG. 6, the apparatus further preferably includes a drying apparatus 246 configured to dry the inorganic particles 107. In the embodiment shown, the drying apparatus 246 is positioned upstream from the delivery conduit 260. The aerosol generator 210 according to one or more embodiments further preferably comprises an agglomerate reducing device, which in the embodiment shown is a roller 248 having ridges 249 on the outer periphery of the roller to break up or pulverize agglomerates and reduce agglomerates of the inorganic particles 107 before being drawn or sucked into the delivery conduit 260. The roller 248 is positioned upstream from the delivery conduit 260. In the embodiment shown, flow generator 130 is positioned at the first end 109 of the duct 110 and upstream from the inlet conduit 116. In some embodiments the flow generator is positioned in or adjacent the exit duct section 110e of the aerosol generator apparatus 103, and gas (e.g., air) flow can be generated in the same direction shown by arrows 101 by directing the fan to draw or suck air through the duct 110.

When high pressure air is forced into the delivery conduit, lightweight inorganic particles at the entrance of the delivery conduit are inhaled due to the negative pressure created by Venturi effect. The aerosol is sheared and exits the Venturi tube into the duct 110. When the aerosol is delivered into the duct 110, the gas volume expands and the flow speed of the inorganic particles 107 is rapidly reduced. The aerosol is then dispersed and carried through the duct 110 preferably by laminar air flow provided by the flow generator 130. The inorganic particles 107 are directed into and onto the porous walls of the plugged honeycomb body. According to some embodiments of the present disclosure, no heat is required to post-treat the honeycomb body after deposition of the inorganic particles; in other embodiments the honeycomb body, and more particularly the inorganic particles, are heat treated, such as to sinter or cure or otherwise adhere the inorganic particles to the porous wall structure.

Embodiments of the apparatus further preferably comprise a homogenizer plate 112 configured to homogenize flow of gas through the duct 110. One or more filters 136, for example HEPA filters are preferably positioned in sections of the duct 110 to filter particles from the gas drawn through the duct by the flow generator 130.

In some embodiments, the aerosol generator apparatus further preferably comprises a first pressure sensor 141 located upstream from the deposition section 410 and a second pressure sensor 143 positioned downstream from the deposition section 410. The apparatus of some embodiments further preferably comprises a humidity sensor 138 and a mass flow controller 134. The first pressure sensor 141 and the second pressure sensor 143 are in some embodiments in communication with a processor 144 which measures a differential pressure between the first pressure sensor 141 and the second pressure sensor 143. In one or more embodiments, the processor 144 may be integral with and/or wired to the first pressure sensor 141 and the second pressure sensor 143, or separate from the first pressure sensor 141 and the second pressure sensor 143. The humidity sensor 138 and the mass flow controller in some embodiments are in communication with the processor 144. In some embodiments the processor 144 comprises includes a central processing unit (CPU), a memory, and support circuits. The processor 144 may be a general-purpose computer processor that can be used in an industrial setting monitoring pressure and calculating a pressure differential between pressure sensors. The memory, or computer readable medium of the processor 144 may be one or more of readily available memory such as random access memory (RAM), read only memory (ROM), floppy disk, hard disk, optical storage media (e.g., compact disc or digital video disc), flash drive, or any other form of digital storage, local or remote. The support circuits are coupled to the CPU for supporting the processor 144. These circuits include cache, power supplies, clock circuits, input/output circuitry and subsystems. One or more processes may be stored in the memory as a software routine that may be executed or invoked to control the operation of the first pressure sensor 141 and the second pressure sensor 143 in the manner described herein. In some embodiments, the processor 144 receives readings from the mass flow controller and the humidity sensor 138, and the processor 144. A control panel 158 on the aerosol generator 210 is also in communication with the processor 144.

Another aspect of the disclosure pertains to a method of applying inorganic particles to a plugged honeycomb body comprising porous walls, an inlet end and an outlet end. Some embodiments of the method comprise flowing the inorganic particles through a Venturi tube and into a duct having a first end and a second end from a dispersion section 405 to a deposition section 410 containing a plugged honeycomb body to deposit the inorganic particles on the porous walls. In one or more embodiments the method is performed using apparatus shown in FIGS. 5-8 and 10. As will be discussed in more detail with respect to FIG., the apparatus of FIG. 10 is configured to apply inorganic particles on a plurality of plugged honeycomb bodies.

One or more embodiments of the method further comprise introducing a flow of air through the duct. This can be accomplished using the flow generator shown in FIG. 5 and FIG. 10, for example a fan, a blower or a vacuum. In some embodiments, a flow generator in fluid communication with the duct and the deposition section is used to generate a flow of inorganic particles mixed with the flow of air. Embodiments of the method preferably include flowing the flow of air through a homogenizer plate, for example the homogenizer plate 112.

In some embodiments, the method further comprises optionally drying the inorganic particles prior to flowing the inorganic particles through the Venturi tube, for example with the drying apparatus 246 shown in FIG. 6. As shown in FIG. 6, the Venturi tube 252 is in communication with a pressurized gas source 270. For example, in some method embodiments, the pressurized Venturi tube 252 with the inlet conduit 116 positioned upstream from the plugged honeycomb body 108, and the pressurized gas (e.g., air) source 270 is connected to the delivery conduit 260.

Embodiments of the method further comprise reducing inorganic particle agglomerates prior to flowing the inorganic particles to the Venturi tube. As described above, the agglomerates are reduced in some embodiments using a roller 248. Some embodiments of the method further comprise measuring pressure upstream and downstream from the plugged honeycomb body.

In exemplary embodiments, the inorganic particle feed system 242 comprises a chain conveyor having four speed modes ranging from 1.25 to 4.0 cm/min, to precisely control the rate of inorganic particle loading. In some embodiments, a plurality of homogenizer plates 112 may be provided, which can be in the form of orifice plates inside the duct to provide for flow lamination and uniformity. In a specific embodiment, there are four homogenizer plates in the duct 110. Temperature and humidity monitors and pressure sensors provide a way to monitor the running conditions. In specific embodiments, the compressed air pressure was 3.0 bar, the roller was rotated at rate of 2.7-3.3 revolutions per minute and the chain conveyor speed was varied between 1.25 and 4.0 cm/min. The flow generator provided an air flow rate ranging from 10 to 40 Nm3/hour in a square duct that was 7 meters in length between the flow generator to the exit duct section 110e.

According to one or more embodiments, wall flow filters can be modified with a surface treatment by depositing inorganic particles onto and/or into the walls or channels of a wall flow filter or filter body. As the inorganic particles deposit onto the inlet channels of the filter they act to occupy pores in the microstructure of the channel walls. During the build-up of the inorganic particles the initial (essentially clean) filtration efficiency of the filter increases from its base value (˜50%) to a much higher values, even greater than 90%.

Commercially available mineral particles can be used for depositing on a plugged honeycomb body. According to one or more embodiments, the particles are selected from particles of alumina, calcium carbonate, kaolin, portland cement, glass, CuO₂, wollastonite, talcum powder, mica powder, silica powder, brucite powder, pyrophyllite, coal ash, dolomite, sepiolite, or combinations thereof.

In some embodiments, the mineral particles, or at least some of the mineral particles, are coated with a surfactant. In some embodiments, the surfactant is one of a fatty acid including a stearate, a phosphate, or a sulfonate fatty acid; a polymer including polymethyl methacrylate, polyethylene glycol, a polyvinyl alcohol, a polymeric acid, a polyacrylic acid, polypropylene, or polyethylene; or mixtures thereof. In some embodiments, the surfactant comprises stearic acid. In some embodiments, the mineral particles consist essentially of calcium carbonate.

In some embodiments, the deposits are present within the plugged honeycomb filter body at a loading of greater than 0.05 to less than or equal to 20 grams of the deposits per liter of the plugged honeycomb filter body, or 2 to 20 grams per liter. In some embodiments, the mineral particles have a D50 particle size distribution falling in the range of from 10 to 600 nm, from 10 to 500 nm, or from 50 to 500 nm.

One or more additional aspects of the disclosure are directed to a filtration article comprising a plugged honeycomb filter body; deposits of inorganic particles disposed within the plugged honeycomb filter body, the deposits having a porosity in a range of greater than 95.0% to less than or equal to 99.9% and an average thickness in a range of greater than or equal to 0.5 μm to less than or equal to 100 μm; and the body having a clean filtration efficiency of greater than or equal to 80% as measured by a liquid phase aerosol filtration efficiency test; wherein the liquid phase aerosol filtration efficiency of the filter body in a clean state, and after being exposed to a humidity resistance test, is greater than or equal to 75%.

In some embodiments, the deposits disposed within the plugged honeycomb filter body are present at a loading of greater than 0.05 and less than or equal to 20 grams of the deposits per liter of the plugged honeycomb filter body. In some embodiments, the inorganic particles comprise particles of calcium carbonate, kaolin, wollastonite, talcum powder, mica powder, silica powder, brucite powder, pyrophyllite, coal ash, dolomite, sepiolite, or combinations thereof. In some embodiments, the particles have a D50 particle size distribution in the range of from 10 to 600 nm, from 10 to 500 nm, or from 50 to 500 nm.

In some embodiments, the inorganic particles, or at least some of the inorganic particles, are coated with a surfactant. In some embodiments, the surfactant is one of a fatty acid including a stearate, a phosphate, or a sulfonate fatty acid; a polymer including polymethyl methacrylate, polyethylene glycol, a polyvinyl alcohol, a polymeric acid, a polyacrylic acid, polypropylene, or polyethylene; or mixtures thereof.

One or more additional aspects of the disclosure are directed to a method of applying or reapplying inorganic particles to a plugged honeycomb body comprising intersecting porous walls extending from an inlet end to an outlet end of the body and defining axial channels, wherein some of the channels are plugged, the method comprising aerosolizing a plurality of inorganic particles having a particle d50 of from 10 to 600 nm, from 10 to 500 nm, or from 50 to 500 nm; and depositing the particles on, in, or both on and in, the porous walls of the plugged honeycomb body. In some embodiments, the aerosolizing comprises passing a suspension of the inorganic particles and a carrier fluid through a venturi tube.

In some embodiments, aerosolizing generates a dry aerosol stream containing the inorganic particles. In some embodiments, the carrier fluid is a gas. In some embodiments, the carrier fluid is an essentially dry gas. In some embodiments, the carrier fluid is a liquid.

In some embodiments, the carrier fluid comprises a liquid, a gas, or a combination thereof. In some embodiments, the inorganic particles comprise particles of calcium carbonate, kaolin, wollastonite, talcum powder, mica powder, silica powder, brucite powder, pyrophyllite, coal ash, dolomite, sepiolite, or combinations thereof. In some embodiments, the inorganic particles are coated with a surfactant. In some embodiments, the inorganic particles comprise calcium carbonate particles.

In one or more embodiments, the particles have an average primary particle size in a range of from about 10 nm to about 10 micrometers, about 20 nm to about 3 micrometers or from about 50 nm to about 2 micrometers, or from about 50 nm to about 900 nm or from about 50 nm to about 600 nm. In specific embodiments, the average primary particle size is in a range of from about 100 nm to about 200 nm, for example, 150 nm.

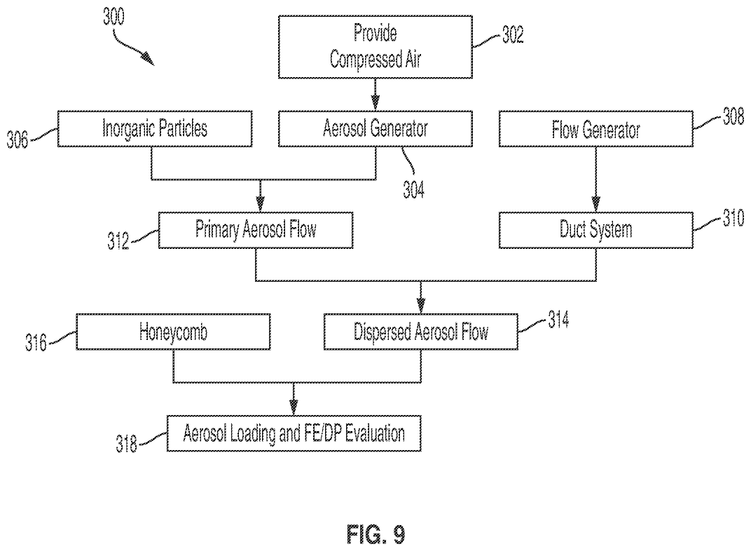

FIG. 9 shows a flow diagram of components of method embodiments for generating an aerosol comprising inorganic particles. Method 301 comprises providing compressed gas such as compressed air at 302. The compressed air is flowed to an aerosol generator at 304 as described above. Inorganic particles are supplied to the aerosol generator at 306. At 308 a flow generator is placed in flow or fluid communication with a duct system as described with respect to FIG. 5. Primary aerosol flow is established by the aerosol generator at 312. The flow of gas such as air provides a dispersed aerosol flow at 314 in the dispersion section 405. A plugged honeycomb body, preferably a plurality of plugged honeycomb bodies, provided at 316 is contacted with the dispersed aerosol flow in a separate deposition section 410, causing aerosol loading at 318 and filtration efficiency and different pressure are evaluated.

Referring now to FIG. 10, an apparatus 400 configured to apply inorganic particles to a plurality of plugged honeycomb bodies is shown. Each of the plurality of the plugged honeycomb bodies comprises porous walls, an inlet end and an outlet end as shown in FIGS. 1-3. In the specific embodiment shown, the apparatus 400 comprises a dispersion section 405 and a deposition section 410 comprising a separate dispersion chamber 410a. The dispersion section 405 and the deposition section 410 can be located in separate chambers in fluid communication by a conduit such as a duct, or alternatively, the dispersion section 405 and the deposition section 410 can be within the same enclosed chamber. According to one or more embodiments, the apparatus 400 comprises the aerosol generator 210 shown and described with respect to FIGS. 5 and 6, and in some embodiments, may further include the venturi tube shown in FIG. 7 and/or the delivery conduit 260 having a flared first end 261 shown in FIGS. 6 and 8.

In the embodiment of the apparatus 400 shown in FIG. 10, the dispersion section 405 comprises a supply duct 402 spanning from a first end 402a to a second end 402b. The dispersion section 405 supply duct 402 is in fluid communication with the aerosol generator 210, and the dispersion section 404 is configured to disperse an aerosol comprising inorganic particles. The apparatus 400 further comprises a connector duct 404 having a first end 404a in fluid communication with the dispersion section 405 and a second end 404b. The deposition section 410 is configured to house the plurality of the plugged honeycomb bodies and is in fluid communication with the second end 404b of the connector duct 404. The apparatus 400 further includes an inlet conduit 406 in fluid communication with the supply duct 402, the inlet conduit upstream from the dispersion section 405. The apparatus further comprises an inorganic particle source 120 (shown in FIG. 6) in fluid communication with the inlet conduit 406 and configured to supply inorganic particles 107 to the inlet conduit 406. An aerosol generator 210 configured to deliver an aerosol comprising the inorganic particles 107 and a gas to the dispersion section is located upstream from the dispersion section 405. The apparatus further comprises a flow generator 408 in fluid communication with the supply duct 402 and the dispersion section 405, the flow generator 408 configured to establish a flow of a gas and the inorganic particles introduced into the supply duct 402. The flow generator 408 is configured to establish a flow of a gas (e.g., air) and the inorganic particles 107 introduced into the supply duct 402 by the aerosol generator 210. Non-limiting examples of a flow generator 408 include a fan, a blower and/or a vacuum pump, which establishes a fluid flow, such as a gas flow (e.g., an air flow, nitrogen flow, or inert gas flow). In some embodiments, there is a nozzle 411 at end of the inlet conduit 406 to deliver the aerosol comprising the inorganic particles 107 into the connector duct 404. In FIG. 10, the flow generator 408 is positioned at the first end 402a of the supply duct 402 and upstream from the inlet conduit 406 connection to supply duct.

The apparatus further comprises an inorganic particle feed system 242 (cf FIG. 6) configured to deliver inorganic particles 107 from the inorganic particle source 120 to the inlet conduit 406. In some embodiments, the apparatus 400 includes a frequency regulator 420 configured to control an operating frequency of the flow generator 408. The frequency regulator 420 is used to control the motor and the fan speed, in order to adjust the flow rate during deposition. The apparatus 400 of some embodiments further includes a humidity and temperature sensor 422 configured to measure temperature and humidity in the supply duct 402 in the dispersion section. In the embodiment shown, the temperature and humidity sensor 422 is shown as an integrated sensor, but in other embodiments, the humidity and temperature sensor 422 can be separate sensors. The apparatus may further include a mass flow meter 424 upstream from the deposition section 410 and in the dispersion section 405 and a differential pressure transmitter 426 in the deposition section 410. The differential pressure transmitter 426 is configured to measure backpressure across the carrier 412.

The locations of the humidity and temperature sensor 422, and the mass flow meter 424 are exemplary, and these components can be located in other locations.

The humidity sensor, the temperature sensor, the mass flow meter and the differential pressure transmitter in some embodiments are in communication with a system processor 430. In one or more embodiments, the system processor 430 may be integral with and/or wired to the processor 144 of the aerosol generator. The system processor 430 of some embodiments comprises includes a central processing unit (CPU), a memory, and support circuits. The system processor 430 may be a general-purpose computer processor that can be used in an industrial setting monitoring pressure and calculating a pressure differential between pressure sensors. The memory, or computer readable medium of the processor 144 may be one or more of readily available memory such as random access memory (RAM), read only memory (ROM), floppy disk, hard disk, optical storage media (e.g., compact disc or digital video disc), flash drive, or any other form of digital storage, local or remote. The support circuits are coupled to the CPU for supporting the system processor 430. These circuits include cache, power supplies, clock circuits, input/output circuitry and subsystems. One or more processes may be stored in the memory as a software routine that may be executed or invoked to control the operation of the humidity and temperature sensor 422, the mass flow meter 424, the frequency regulator 420, and the differential pressure transmitter 426. In some embodiments, the system processor 430 receives readings from the mass flow meter 424 humidity and temperature sensor 422, the mass flow meter 424, the frequency regulator 420, and the differential pressure transmitter 426. In some embodiments, the system processor 430 communicates with the flow generator 408 and with the mass flow meter 424 to provide a closed-loop control and continuous steady gas flow to the carrier 412. In some embodiments, the dispersion section 405 has a volume and the deposition section 410 has a volume that is greater than the volume of the dispersion section. In some embodiments, the dispersion section 405 has a maximum cross-sectional area and the deposition section 410 has a maximum cross sectional area that is greater than the maximum cross-sectional area of the dispersion section, and an aerosol flow velocity through the dispersion section is greater through the dispersion section than in the deposition section. In some embodiments, the deposition section 410 has a cross-sectional area and the dispersion section 405 has a cross-sectional area, and the cross-sectional area of the dispersion section 405 and the cross-sectional area of the deposition section 410 are configured so that there is a ratio of a flow velocity in the dispersion section to a flow velocity in the deposition section in a range from 2:1 to 50:1, for example, 5:1 to 30:1, specifically, 10:1 to 20:1. In one or more embodiments, the flow rate in the dispersion section is higher than the deposition section. This flow rate difference can be realized by multiple approaches, such as a change in volume of the sections. Thus, in some embodiments, the deposition section has an average gas flow rate, and the dispersion section has an average gas flow rate that is greater than that of the deposition chamber

In one or more embodiments, the apparatus 400 comprises at least one flow distributor plate 432 upstream from the carrier 412. In some embodiments of the apparatus 400, there are three flow distributor plates 432, each of the three flow distributor plates comprising orifices configured to distribute flow of gas to the carrier. The apparatus 400 in some embodiments may comprise a moisture trapping device 434 to reduce moisture from the aerosol before entering the deposition section 410. The moisture trapping device 434 may be in communication with the system processor 430. The apparatus 400 may further comprise a filter 435 such as a HEPA filter downstream from the carrier 412.

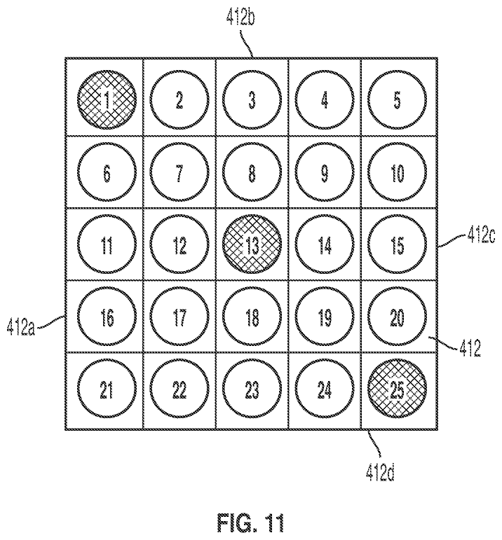

In one or more embodiments, the apparatus comprises a carrier 412 configured to support the plurality of plugged honeycomb bodies in the deposition section 410. FIG. 11 shows a top plan view of a carrier configured to support a plurality of plugged honeycomb bodies, numbered 1 through 25. The carrier 412 can be configured in any way suitable to hold a plurality of plugged honeycomb bodies. In the embodiment shown the carrier 412 is in the form of a cubic box having a square or rectangular cross section and four walls 412a, 412b, 412c and 412d. However, the carrier 412 is not limited to the shape or configuration shown. In one or more embodiments, the carrier 412 is configured to support a range from four plugged honeycomb bodies to 200 plugged honeycomb bodies. In some embodiments, the carrier 412 is configured to support a range of 4-150, 4-100, 4-90, 4-80, 4-70, 4-60, 4-50, 4-40, 4-30, 4-20, 4-10, 10-200, 10-150, 10-90, 10-80, 10-70, 10-60, 10-50, 10-40, 10-30, 10-20, 20-200, 20-150, 20-100, 20-90, 20-80, 20-70, 20-60, 20-50, 20-40 or 20-30 plugged honeycomb bodies. In one or more embodiments, the carrier 412 is configured to support an array of plugged honeycomb bodies. The array of plugged honeycomb bodies can include any number, such as the 5×5 array shown in FIG. 11. In some embodiments, the carrier is configured to support a range from 2 plugged honeycomb bodies to 100 plugged honeycomb bodies. In some embodiments, the carrier is configured to support a range from 4 to 25 plugged honeycomb bodies.

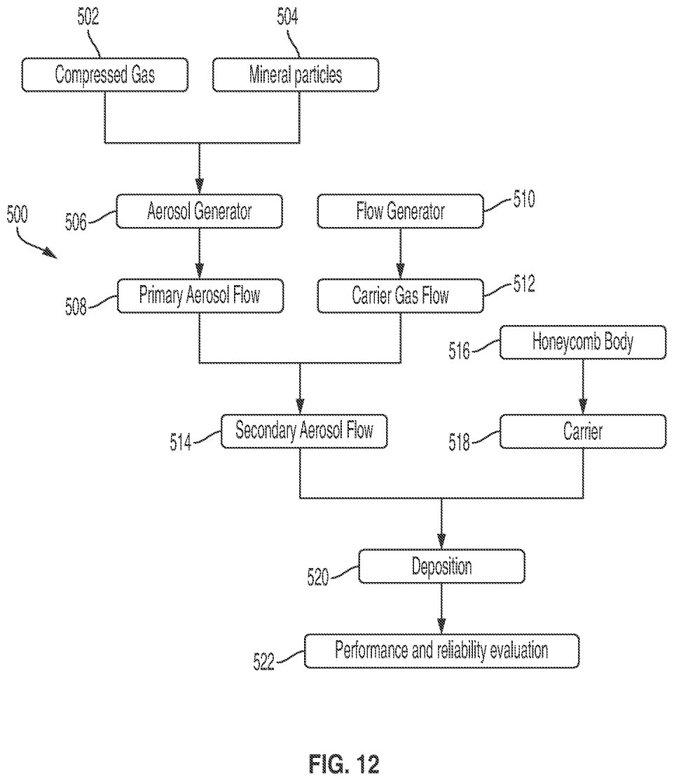

Referring now to FIG. 12, another aspect of the disclosure pertains to a method 500 of applying inorganic particles to a plugged honeycomb body comprising porous walls, an inlet end and an outlet end. In an embodiment, the method comprises flowing an aerosol comprising the inorganic particles 107 through the dispersion section 405 and dispersing the aerosol prior to flowing the inorganic particles 107 through a deposition section 410 in which the aerosol is deposited on the plugged honeycomb body.

The method 500 may further include placing a plurality of plugged honeycomb bodies in the deposition section 410 and depositing the inorganic particles on the plurality of plugged honeycomb bodies. The plurality of plugged honeycomb bodies may include the number of plugged honeycomb bodies described herein.

The method may further comprise generating a flow of a gas such as a compressed gas 502 with entrained inorganic particles 504 through a supply duct 402 in communication with the dispersion section 405, for example using an aerosol generator 506. A primary aerosol flow is formed at 508, and the method 500 includes delivering the inorganic particles from the inorganic particle source to the supply duct 402. This can be done at using the flow generator at 510 to establish carrier gas flow at 512. A secondary aerosol may be established at 514, and a plugged honeycomb body at 516 in a carrier at 518 has the inorganic particles deposited thereon at 520. The plugged honeycomb bodies may be evaluated for performance and for process reliability at 522. Thus, the method 500 includes generating an aerosol comprising the inorganic particles and a gas.

In one or more embodiments of the method 500, the plurality of plugged honeycomb bodies are placed in a carrier in the deposition section in an array and simultaneously depositing the aerosol on the plurality of plugged honeycomb bodies. Using the apparatus 400, the method further comprises monitoring humidity with a humidity sensor and temperature with a temperature sensor in the supply duct 402. The method 500 of some embodiments uses a mass flow meter upstream from the deposition section and monitors a differential pressure transmitter in the deposition section. The method 500 also includes controlling with a system processor 430 the humidity sensor, the temperature sensor, the mass flow meter and the differential pressure transmitter. Some embodiments of the method 500 includes measuring backpressure across the carrier with the differential pressure transmitter.

The system processor 430 is used to communicate with a flow generator and with a mass flow meter to provide a closed-loop control and continuous steady gas flow to the carrier. The method 500 of some embodiments further comprise flowing the aerosol across at least one flow distributor plate upstream from the carrier.

According to one or more embodiments, the apparatus and methods provide for scale-up and high-speed deposition on multiple plugged honeycomb bodies. The apparatus and process are relative fast, and deposition on an array of twenty-five plugged honeycomb bodies can processed within 1.5 minutes with >90% target FE with uniformity. A dual-chamber system which used a small chamber to enhance the dispersion of particle materials and a much larger chamber to slow down the gas flow to improves deposition uniformity.

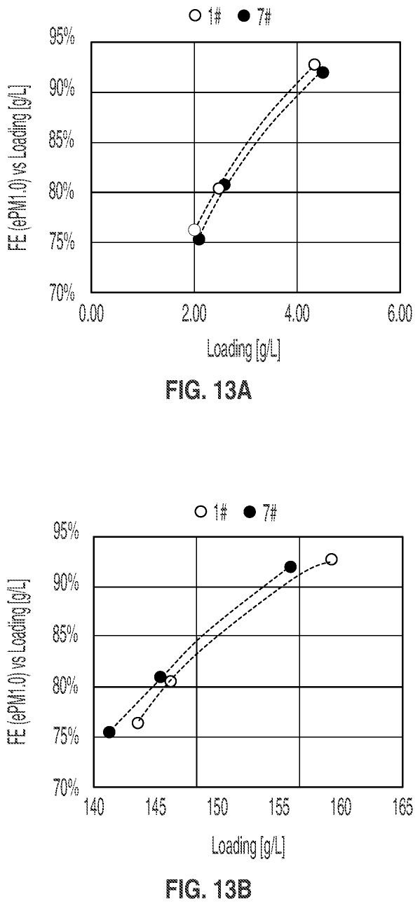

The FE and loading efficiency of this apparatus and methods described herein were demonstrated higher than processing each plugged honeycomb body individually. Loading of up to 5 g/l were demonstrated compared to only 2.2. g/L when deposition was performed on individual parts. FIGS. 13A and 13 B show filtration efficiencies vs. loading for two of 25 random samples in 5×5 array as shown in FIG. 11. The measurements were obtained according to by ISO 16890-1:2016 (E): Air filters for general ventilation-part 1: Technical specifications, requirements and classification system based upon particulate matter efficiency. ePM1.0 was the efficiency of an air cleaning device to reduce the mass concentration of particles with an optical diameter between 0.3 um and 1 um; it was used to measure PM filter performance.

Table 1 shows exemplary parameters for the apparatus and method

TABLE 1

| Parameters | Value |
|---|---|
| Total gas flow [Nm³/h] | 640 |
| Headspace length [mm] | 2000 |
| Headspace width [mm] | 710 |
| Residence time [s] | 5.67 |
| Carrier gas velocity in deposition section | 0.35 |
| [m/s] | |
| Dispersion section diameter [mm] | 200 |
| Dispersion section length [mm] | 2000 |
| Residence time in dispersion section [s] | 0.35 |
| Carrier gas velocity in dispersion section [m/s] | 5.66 |

In an experimental run, the flow velocity in dispersion section was up to 5.66 m/s while the flow velocity in the deposition section was only 0.35 m/s. The design of dual-chamber utilizes this high-speed air flow to disperse individual and agglomerates of the inorganic particles and then transport them into the larger deposition section and slow down the speed spontaneously which positively impacted the deposition uniformity. Deposition of well-dispersed inorganic particles using the apparatus and methods provided unexpected deposition efficiency and effectiveness to improve the filtration performance of filtration article products.

Utilization of three orifice plates with a spacing of 50 mm from one another between the chambers and one HEPA filter at the bottom of the deposition section distributed the gas flow for deposition uniformity. The HEPA filter also control the potential emission of fine particles.

Experimental runs using CaCO₃ (D50=50 nm and 500 nm and glass powder on multiple plugged honeycomb bodies in a carrier were nearly equivalent to a part-by-part deposition process. A panel was assembled with nine pieces of 5.2″×4.5″ GC of 200 cpsi, 8 mil wall thickness, d50˜13.5 micron, porosity 55%) gasoline particulate filter bodies and the panel was processed simultaneously in which inorganic particles were deposited on the entire panel in a single run. Besides the shorter deposition time, the FE/loading efficiency of the multiple plugged honeycomb body deposition apparatus and process was higher over that of part-by-part process, which meant the prototype system could achieve the same FE target with less material on each plugged honeycomb body with minimal loading variance (about 1.4%) between each part. Each of the parts can be performance tested using one or more of the tests described below.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. An apparatus configured to apply particles to a plurality of plugged honeycomb bodies, each of the plurality of the plugged honeycomb bodies comprising porous walls, an inlet end and an outlet end, the apparatus comprising:
a supply duct spanning from a first end to a second end;
a dispersion section in fluid communication with the second end of the supply duct, the dispersion section configured to disperse an aerosol comprising inorganic particles;
a connector duct having a first end in fluid communication with the dispersion section and a second end;
a deposition section configured to house the plurality of the plugged honeycomb bodies and in fluid communication with the second end of the connector duct;
an inlet conduit in fluid communication with the supply duct, the inlet conduit upstream from the dispersion section;
an inorganic particle source in fluid communication with the inlet conduit and configured to supply inorganic particles to the inlet conduit;
an aerosol generator configured to deliver an aerosol comprising the inorganic particles and a gas to the dispersion section;
a flow generator in fluid communication with the supply duct and the dispersion section, the flow generator configured to establish a flow of a gas and the inorganic particles introduced into the supply duct; and
a carrier configured to support the plurality of plugged honeycomb bodies in the deposition section.

2. The apparatus of claim 1, wherein the dispersion section and the deposition section are located in the same chamber.

3. The apparatus of claim 1, wherein the dispersion section and the deposition section are in separate chambers.

4. The apparatus of claim 1, wherein the carrier is configured to support a range from 2 plugged honeycomb bodies to 100 plugged honeycomb bodies.

5. (canceled)

6. (canceled)

7. The apparatus of claim 1, further comprising an inorganic particle feed system configured to deliver inorganic particles from the inorganic particle source to the inlet conduit.

8. (canceled)

9. (canceled)

10. (canceled)

11. The apparatus of claim 1, further comprising a frequency regulator configured to control an operating frequency of the flow generator.

12. The apparatus of claim 2, further comprising a humidity sensor configured to measure humidity in the supply duct and a temperature sensor configured to measure temperature in the supply duct.

13. The apparatus of claim 12, further comprising a mass flow meter upstream from the chamber and a differential pressure transmitter in the deposition section.

14. The apparatus of claim 13, the humidity sensor, the temperature sensor, the mass flow meter and the differential pressure transmitter in communication with a processor.

15. (canceled)

16. (canceled)

17. The apparatus of claim 2, wherein the deposition section has a cross-sectional area and the dispersion section has a cross-sectional area, and the cross-sectional area of the dispersion section and the cross-sectional area of the deposition section are configured so that there is a ratio of a flow velocity in the dispersion section to a flow velocity in the deposition section in a range from 2:1 to 50:1.

18. The apparatus of claim 17, wherein the dispersion section has a maximum cross-sectional area and the deposition section has a maximum cross-sectional area that is greater than the maximum cross-sectional area of the dispersion section, and an aerosol flow velocity through the dispersion section is greater through the dispersion section than in the deposition section.

19. The apparatus of claim 17, wherein the dispersion section has a volume and the deposition section has a volume that is greater than the volume of the dispersion section.

20. (canceled)

21. (canceled)

22. A method of applying inorganic particles to a plugged honeycomb body comprising porous walls, an inlet end and an outlet end, the method comprising flowing an aerosol comprising the inorganic particles through a dispersion section and dispersing the aerosol prior to flowing the inorganic particles through a deposition section in which the aerosol is deposited on the plugged honeycomb body.

23. The method of claim 22, further comprising placing a plurality of plugged honeycomb bodies in the deposition section and depositing the inorganic particles on the plurality of plugged honeycomb bodies.

24. (canceled)

25. (canceled)

26. The method of claim 23, further comprising:
generating a flow of a gas through a supply duct in communication with the dispersion section; and
delivering the inorganic particles from an inorganic particle source to the supply duct; and
generating an aerosol comprising the inorganic particles and a gas.

27. The method of claim 26, wherein the plurality of plugged honeycomb bodies are placed in a carrier in the deposition section in an array and simultaneously depositing the aerosol on the plurality of plugged honeycomb bodies.

28. The method of claim 27, wherein the carrier is configured to support a range from 2 plugged honeycomb bodies to 100 plugged honeycomb bodies.

29. (canceled)

30. (canceled)

31. The method of claim 27, further comprising monitoring humidity with a humidity sensor and temperature with a temperature sensor in the supply duct.

32. The method of claim 31, further comprising monitoring a mass flow meter upstream from the deposition section and monitoring a differential pressure transmitter in the deposition section.

33. (canceled)

34. (canceled)

35. (canceled)

36. The method of claim 27, wherein the dispersion section has a volume and the deposition section has a volume that is greater than the volume of the dispersion section.

37. (canceled)

38. (canceled)

39. (canceled)

40. (canceled)
